(19) United States
(12) Patent Application Publication
(10) Pub. No.: US 2007/0041760 A1
(43) Pub. Date: Feb. 22, 2007

(54) Laser printer and perfume device thereof

(75) Inventor: Jian Zhang, Suzhou City (CN)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/506,999

(22) Filed: Aug. 21, 2006

(30) Foreign Application Priority Data
Aug. 22, 2005 (TW) 94128646

(51) Int. Cl. G03G 15/20

(52) U.S. Cl. 399/341

(57) ABSTRACT

A laser printer comprises a supporting roller, a fusing roller, and a solid perfume. The fusing roller is disposed opposite the supporting roller. The supporting roller and the fusing roller are rotated synchronously to heat, and press against two sides of a sheet medium carrying a patterned toner, so that the toner is fixed on the sheet medium, and then the sheet medium is pushed out. The solid perfume is adjacent to the fusing roller and close to the sheet medium output from the fusing roller so as to release perfume to the sheet medium.

This application claims the benefit of Taiwan application Serial No. 094128646, filed Aug. 22, 2005, the subject matter of which is incorporated herein by reference.

### BACKGROUND OF THE INVENTION

1. Field of the Invention

The invention relates in general to a laser printer, and more particularly to a laser printer which is able to perfume the sheet medium.

2. Description of the Related Art

Printers are widely applied to varied fields including office, school, and laboratory etc. Printers generally include laser printers and ink jet printers. Laser printers are characterized by durability, high-speed printing rate, great printing quality, so that the laser printer is popular in the enterprise.

The last step of the printing is fusing the toner on the paper by a heating roller. However, the material of the roller, such as plastic material or synthetic chemicals, will produce unpleasant odor when heating. Through the last step of the printing, the unpleasant odor will be transferred to the paper.

### SUMMARY OF THE INVENTION

It is therefore an object of the invention to provide a laser printer which can print out sheet medium with fragrance.

The invention achieves the above-identified object by providing a laser printer, comprising a supporting roller, a fusing roller, and a solid perfume. The fusing roller is disposed opposite the supporting roller. The supporting roller and the fusing roller are rotated synchronously to heat and press against two sides of a sheet medium carrying a patterned toner, whereby the toner is fixed on the sheet medium, and then the sheet medium is pushed out. The solid perfume is adjacent to the fusing roller and close to the sheet medium output from the fusing roller so as to release perfume to the sheet medium.

Moreover, the invention achieves the above-identified object by providing a perfume device for mounting in a laser printer. The laser printer comprising a supporting roller and a fusing roller opposed thereto, and the supporter roller and the fusing roller are rotated synchronously to heat and squeeze a sheet medium carried with a patterned toner. Thus, the toner is fixed on the sheet medium, and then the sheet medium is output. The perfume device comprises a perfume shaft and a supporting shaft. The perfume shaft is adjacent to the fusing roller and close to the sheet medium output from the fusing roller, so that a perfume sublimed from the solid perfume is generated by heat radiated from the heating roller and released to the sheet medium, whereby the sheet medium is perfumed. The supporting shaft is disposed opposite the perfume shaft, and rotated with the perfume shaft synchronously.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is block diagram illustrating a laser printer according to preferred embodiment of the present invention.

FIG. 2 is a partially lateral view of the laser printer in FIG. 1 according to preferred embodiment of the invention.

### DETAILED DESCRIPTION OF THE INVENTION

The present invention now will be described more fully hereinafter with reference to the accompanying drawings, in which preferred embodiment of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

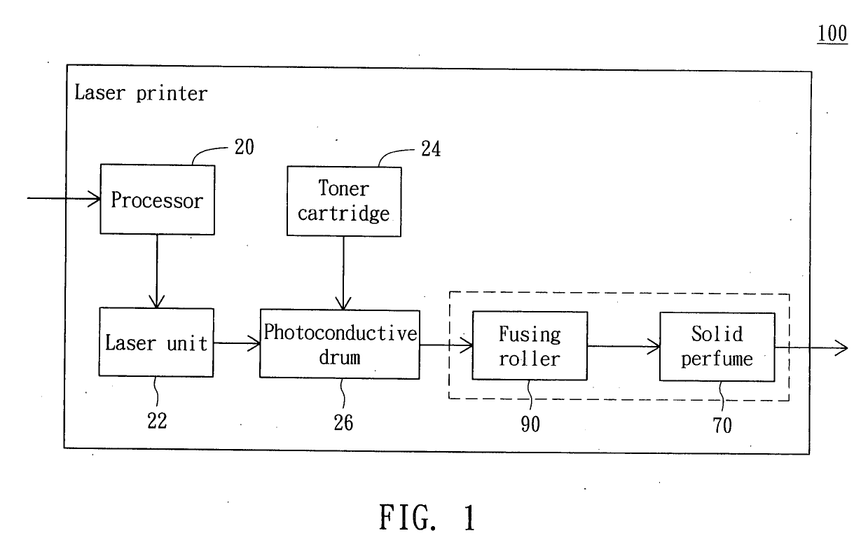

Referring to FIG. 1, which is block diagram illustrating a laser printer according to preferred embodiment of the present invention. The laser printer 100 of the present embodiment includes a processor 20, a laser unit 22, a photoconductive drum 26, a toner cartridge 24, a supporting roller 80, a fusing roller 90, and a solid perfume 70. The method for printing in the laser printer 100 includes the steps of charging, laser sensitization, spreading toner, transferring, pressing and heating. Firstly, negative charges are spread on the whole photoconductive drum 26. Then, print data receiving from the computer are calculated by the processor 20, and the laser unit 22 received the processed data. The laser unit 22 partially discharges the negative charges according to the process data, that is, the negative charges located in the print image region are left, and the negative charges located in the blank region are removed so as to form a printed-image-like charging pattern on the photoconductive drum 26. Then, the toner restored in the toner cartridge 24 is evenly spread on the photoconductive drum 26. Owing to the electric attraction to the negative charges, the toner is attracted to the photoconductive drum 26 to form a print image according to the pattern of the negative charges formed by the laser unit 22. Next, a sheet medium which is sent to face the photoconductive drum 26, and the toner on the photoconductive drum 26 is transferred to the sheet medium.

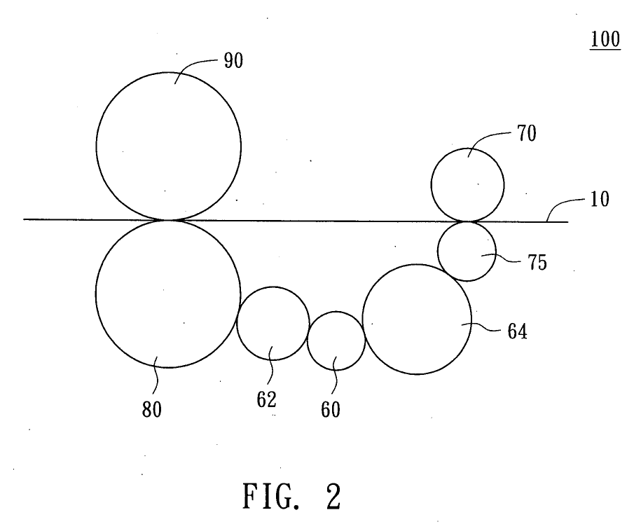

Finally, the toner spread on the sheet medium is fused to the sheet medium by heat and pressure. Referring to FIG. 2, which is a partially lateral view of the laser printer in FIG. 1 according to preferred embodiment of the invention. The fusing roller 90 is disposed opposite the supporting roller 80. The supporting roller 80 and the fusing roller 90 are rotated synchronously to heat and press against two sides of a sheet medium carrying a patterned toner, so that the toner is fixed on the sheet medium, and then the sheet medium is pushed out. The solid perfume is adjacent to the fusing roller and close to the sheet medium output from the fusing roller so as to release perfume to the sheet medium. The solid perfume is preferably embodied in a perfume shaft in the preferred embodiment.

Further, a perfume, preferably sublimed from the solid perfume, is generated by heat radiated from the heating roller 90 and released to the sheet medium, so that the sheet medium is perfumed. Preferably, the solid perfume presses against the sheet medium 10, and then the perfume will be easily to reach the sheet medium.

The solid perfume may be embodied in many different forms and should not be construed as limited to the embodiments set forth herein. For example, the solid perfume is a perfume shaft. The laser printer 100 further comprises a supporting shaft 75, and a lateral surface of the perfume shaft 70 is contacted by the sheet medium 10 when the perfume shaft 70 is rotated. The supporting shaft 75 is disposed opposite the perfume shaft 70, and rotated with the perfume shaft 70 synchronously. The supporting shaft 75 is used for supporting the sheet medium 10, so that the perfume shaft 70 could press against the sheet medium 10 to release perfume to the sheet medium 10.

The laser printer further comprises a driving assembly, and the driving assembly comprises an active gear 60, a first speed-changing gear 62, a second speed-changing gear 64. The first speed-changing gear 60 is meshed with the active gear 60 and the supporting roller 80. The second speed-changing gear 64 is meshed with the active gear 60 and the supporting shaft 75. The active gear 60 drives the first speed-changing gear 62, the second speed-changing gear 64, the supporting roller 80 and the supporting shaft 75, and the supporting shaft 75 is rotated with the perfume shaft 70 synchronously, so that when the driving assembly transfers the sheet medium 10 in a tangential velocity, the perfume shaft 70 is rotated in the tangential velocity to release the perfume to the sheet medium 10.

In addition, the supporting roller 80 can be another fusing roller, so that the supporting roller 80 and the fusing roller 90 can jointly fuse and fix the toner on the sheet medium 10 by heat and pressure. In the other hand, the solid perfume shaft 70 is able to be disassembled from the printer, and the solid perfume with various flavors is easily to be assembled in the printer according to personal preference.

The laser printer and the perfume device thereof disclosed in the preferred embodiments stated above, whose solid perfume is set as a perfume shaft adjacent the fusing roller. The solid perfume is sublimed by heat of the fusing roller, and then release perfume to the paper. It allows not only to diminish the unpleasant odor on the printed out sheet medium inevitably resulting from the conventional laser printer, but also creating the sheet medium with special fragrance. Such design which gets ahead the trend of the market would improve the competitiveness of the product.

While the invention has been described by way of examples and in terms of the preferred embodiments, it is to be understood that the invention is not limited thereto. For example, the two reflective planes are utilized for guiding electromagnetic signals from two different directions in the embodiment, but people who skilled in the art realize that several reflectors could be used for guiding electromagnetic signals from several directions. It is intended to cover various modifications and similar arrangements and procedures, and the scope of the appended claims therefore should be accorded the broadest interpretation so as to encompass all such modifications and similar arrangements and procedures.

What is claimed is:

1. A laser printer, comprising:
a supporting roller,
a fusing roller, disposed opposite the supporting roller, wherein the supporting roller and the fusing roller are rotated synchronously to heat and press against two sides of a sheet medium carrying a patterned toner, whereby the toner is fixed on the sheet medium, and then the sheet medium is pushed out; and
a solid perfume, adjacent to the fusing roller and close to the sheet medium output from the fusing roller so as to release perfume to the sheet medium.

2. The laser printer according to claim 1, wherein the solid perfume is press against the sheet medium.

3. The laser printer according to claim 2, wherein the solid perfume is a perfume shaft, a lateral surface of the perfume shaft is contacted by the sheet medium when the perfume shaft is rotated.

4. The laser printer according to claim 3 further comprising a supporting shaft, disposed opposite the perfume shaft and rotated with the perfume shaft synchronously;
wherein the supporting shaft is used for supporting the sheet medium, so that the perfume shaft presses against the sheet medium to release perfume to the sheet medium.

5. The laser printer according to claim 4 further comprising a driving assembly, the driving assembly comprising:
an active gear;
a first speed-changing gear, meshed with the active gear and the supporting roller; and
a second speed-changing gear, meshed with the active gear and the supporting shaft;
wherein the active gear drives the first speed-changing gear, a second speed-changing gear, the supporting roller and the supporting shaft, and the supporting shaft is rotated with the perfume shaft synchronously, so that when the driving assembly transfers the sheet medium in a tangential velocity, the perfume shaft is rotated in the tangential velocity to release the perfume to the sheet medium.

6. The laser printer according to claim 3, wherein the perfume shaft is able to disassembled from the printer.

7. A perfume device for mounting in a laser printer, the laser printer comprising a supporting roller and a fusing roller opposed thereto, the supporter roller and the fusing roller rotated synchronously to heat and squeeze a sheet medium carried with a patterned toner, whereby the toner is fixed on the sheet medium, and then the sheet medium is output, the perfume device comprising:
a perfume shaft, adjacent to the fusing roller and close to the sheet medium output from the fusing roller, so that a perfume sublimed from the solid perfume is generated by heat radiated from the heating roller and released to the sheet medium, whereby the sheet medium is perfumed; and
a supporting shaft, disposed opposite the perfume shaft and rotated with the perfume shaft synchronously.

8. The perfume device according to claim 7 further comprising a driving assembly, the driving assembly comprising:
an active gear;
a first speed-changing gear, meshed with the active gear and the supporting roller; and
a second speed-changing gear, meshed with the active gear and the supporting shaft;
wherein the active gear drives the first speed-changing gear, a second speed-changing gear, the supporting roller and the supporting shaft, and the supporting shaft is rotated with the perfume shaft synchronously, so that when the driving assembly transfers the sheet medium in a tangential velocity, the perfume shaft is rotated in the tangential velocity to release the perfume to the sheet medium.
